(19) United States
(12) Patent Application Publication
(10) Pub. No.: US 2023/0302619 A1
(43) Pub. Date: Sep. 28, 2023

(54) TOOL BIT

(71) Applicant: MILWAUKEE ELECTRIC TOOL CORPORATION, Brookfield, WI (US)

(72) Inventors: Joseph D. Greaney, Milwaukee, WI (US); Travis J. DuMez, Port Washington, WI (US)

(21) Appl. No.: 18/129,981

(22) Filed: Apr. 3, 2023

Related U.S. Application Data
(63) Continuation of application No. 17/697,250, filed on Mar. 17, 2022.
Application No. 17/697,250 is a continuation of application No. PCT/US2022/012536, filed on Jan. 14, 2022.
(60) Provisional application No. 63/160,080, filed on Mar. 12, 2021.
(60) Provisional application No. 63/137,518, filed on Jan. 14, 2021.

(51) Int. Cl. B25D 17/08; B25D 17/02; B23B 51/04; B23P 15/28; B23B 51/00

(52) U.S. Cl. CPC B25D 17/088; B23B 51/00; B23B 51/04; B23P 15/28; B25D 17/02; B23B 2222/84; B23B 2226/75; B23B 2228/36; B25D 2216/0023; B25D 2217/0007

(57) ABSTRACT

A tool bit for use with a power tool having a chuck and an anvil. The tool bit has a body defining the first end of the tool bit, and a shank coupled to the body and defining the second end of the tool bit. The shank includes a slot, a ball detent, and a projection. The slot is formed through the second end and is configured to receive a portion of the chuck to transfer rotational movement from the power tool to the tool bit. The ball detent is spaced circumferentially from the slot and is configured to receive a locking sphere of the chuck to lock the tool bit with the chuck. The projection is configured to contact a surface of the chuck and limit insertion of the shank into the chuck, thereby providing a space between the second end of the tool bit and the anvil.

### CROSS-REFERENCE TO RELATED APPLICATIONS

This application is a continuation of U.S. Non-Provisional Pat. Application No. 17/697,250 filed on Mar. 17, 2022, which is a continuation of International Patent Application No. PCT/US2022/012536 filed on Jan. 14, 2022, which claims priority to U.S. Provisional Pat. Application No. 63/137,518 filed on Jan. 14, 2021, and to U.S. Provisional Pat. Application No. 63/160,080 filed on Mar. 12, 2021, the entire contents of which are incorporated by reference herein.

### FIELD OF INVENTION

The present invention relates to tool bits. More particularly, the present invention relates to tool bits for use with hammer-type drills.

### BACKGROUND

Rebar cutter bits are generally used with power tools such as rotary drills or hammer-type drills to cut through concrete that includes rebar. Rebar cutter bits include a cutting tip that is specifically designed to cut through rebar. Occasionally, rebar cutter bits are used with power tools that include an anvil that are operable in a rotary impact/hammer mode where the anvil strikes a bit during rotation to increase the cutting performance. However, for some rebar cutter bits, it is undesirable for the anvil to strike the bit as it may cause damage to the bit.

### SUMMARY OF THE INVENTION

In one aspect, the invention provides a tool bit for use with a power tool having a chuck and an anvil. The tool bit has a first end, a second end opposite the first end, a body defining the first end of the tool bit, and a shank coupled to the body and defining the second end of the tool bit. The shank is configured to be inserted into the chuck of the power tool. The shank includes a slot formed through the second end. The slot is configured to receive a portion of the chuck to transfer rotational movement from the power tool to the tool bit. The shank also includes a ball detent spaced circumferentially from the slot. The ball detent is configured to receive a locking sphere of the chuck to lock the tool bit with the chuck. The slot is sized to limit insertion of the shank into the chuck, thereby providing a space between the second end of the tool bit and the anvil.

In some aspects, the space inhibits the second end of the tool from contacting the anvil during operation of the power tool.

In some aspects, the slot has a length. The length is between 0.2 inches and 1 inch.

In some aspects, the slot has a slot length and the ball detent has a ball detent length. A ratio of the ball detent length to the slot length is between 0.85 and 1.15.

In some aspects, the slot has a proximal slot end adjacent the second end of the tool bit and a distal slot end opposite the proximal slot end. The ball detent has a proximal ball detent end adjacent the second end of the tool bit and a distal ball detent end opposite the proximal ball detent end. The distal ball detent end is spaced generally the same distance from the first end of the tool bit as the second slot end.

In some aspects, the slot has a proximal slot end adjacent the second end of the tool bit and a distal slot end opposite the proximal slot end. The ball detent has a proximal ball detent end adjacent the second end of the tool bit and a distal ball detent end opposite the proximal ball detent end. The distal slot end is closer than the distal ball detent end to the second end of the tool bit.

In some aspects, the slot extends from the second end of the tool bit but does not extend past the ball detent in a direction parallel to an axis of rotation of the tool bit.

In some aspects, the slot is a first slot. The ball detent is a first ball detent. The shank further includes a second slot positioned diametrically opposite from the first slot and formed through the second end. The second slot is configured to receive another portion of the chuck to transfer rotational movement from the power tool to the tool bit. The shank further includes a second ball detent positioned diametrically opposite from the first ball detent. The second ball detent is configured to receive another locking sphere of the chuck to lock the tool bit within the chuck.

In some aspects, the ball detent is bounded on all sides.

In another aspect, the invention provides a tool bit for use with a power tool having a chuck and an anvil. The tool bit has a first end, a second end opposite the first end, a body defining the first end of the tool bit, and a shank coupled to the body and defining the second end of the tool bit. The shank is configured to be inserted into the chuck of the power tool. The shank includes a slot formed through the second end. The slot is configured to receive a portion of the chuck to transfer rotational movement from the power tool to the tool bit. The shank also includes a ball detent spaced circumferentially from the slot. The ball detent is configured to receive a locking sphere of the chuck to lock the tool bit with the chuck. The shank further includes a projection. The projection is configured to contact a surface of the chuck and limit insertion of the shank into the chuck, thereby providing a space between the second end of the tool bit and the anvil.

In some aspects, the space inhibits the second end of the tool from contacting the anvil during operation of the power tool.

In some aspects, the projection is a shoulder formed at an increased diameter portion of the shank. The shoulder extends continuously around a circumference of the shank.

In some aspects, the slot has a proximal end adjacent the second end of the tool bit and a distal end opposite the proximal end. The projection is adjacent the distal end of the slot.

In some aspects, the slot is a first slot. The ball detent is a first ball detent. The shank further includes a second slot positioned diametrically opposite from the first slot and formed through the second end. The second slot is configured to receive another portion of the chuck to transfer rotational movement from the power tool to the tool bit. The shank further includes a second ball detent positioned diametrically opposite from the first ball detent. The second ball detent is configured to receive another locking sphere of the chuck to lock the tool bit within the chuck.

In some aspects, the ball detent is bounded on all sides.

In another aspect, the invention provides a tool bit for use with a power tool having a chuck and an anvil. The tool bit has a first end, a second end opposite the first end, a body defining the first end of the tool bit, and a shank coupled to the body and defining the second end of the tool bit. The shank is configured to be inserted into the chuck of the power tool. The shank includes a first slot formed through the second end. The first slot is configured to receive a first portion of the chuck to transfer rotational movement from the power tool to the tool bit. The shank also includes a second slot positioned diametrically opposite from the first slot and formed through the second end. The second slot is configured to receive a second portion of the chuck to transfer rotational movement from the power tool to the tool bit. The shank further includes a first ball detent spaced circumferentially from the first and second slots. The first ball detent is configured to receive a first locking sphere of the chuck to lock the tool bit within the chuck. The shank also includes a second ball detent positioned diametrically opposite from the first ball detent. The second ball detent is configured to receive a second locking sphere of the chuck to lock the tool bit within the chuck. The shank is configured to limit insertion of the shank into the chuck such that the second end of the tool bit is not contacted by the anvil during operation of the power tool.

In some aspects, the first slot and the second slot are sized to limit insertion of the shank into the chuck.

In some aspects, the first slot and the second slot extend from the second end of the tool bit but do not extend past the first ball detent or the second ball detent in a direction parallel to an axis of rotation of the tool bit

In some aspects, the shank includes an increased diameter portion that is configured to contact a surface of the chuck to limit insertion of the shank into the chuck.

The above aspects may be used in any combination with each other. Other aspects of the invention will become apparent by consideration of the detailed description and accompanying drawings.

### BRIEF DESCRIPTION OF THE DRAWINGS

FIG. 1 is a perspective view of a tool bit.

FIG. 2 is a front perspective view of the tool bit of FIG. 1.

FIG. 3 illustrates a carbide tooth of the tool bit of FIG. 1.

FIG. 4 is a perspective view of a shank of the tool bit of FIG. 1.

FIG. 5 is a first elevational view of the shank of FIG. 4.

FIG. 6 is a second elevational view of the shank of FIG. 4.

FIG. 7 is a cross-sectional view of the tool bit of FIG. 1 coupled to a power tool.

FIG. 8 is a cross-sectional view of a tool bit according to another embodiment, the tool bit coupled to the power tool.

FIG. 9 is a first perspective view of a tool bit according to another embodiment.

FIG. 10 is a second perspective view of the tool bit of FIG. 9.

FIG. 11 is a front elevational view of the tool bit of FIG. 9.

FIG. 12 is a rear elevational view of the tool bit of FIG. 9.

FIG. 13 is an elevational view of a tool bit according to another embodiment.

FIGS. 14A-14L illustrate a variety of different types of tool bits having modified shanks.

FIG. 15 is a cross-sectional view of the tool bit of FIG. 9 taken along lines 15-15.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

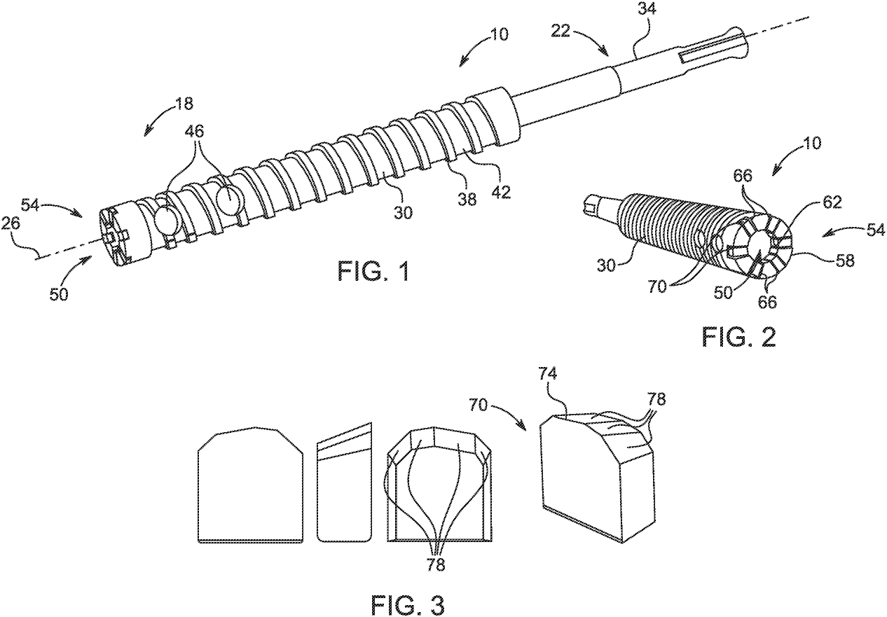

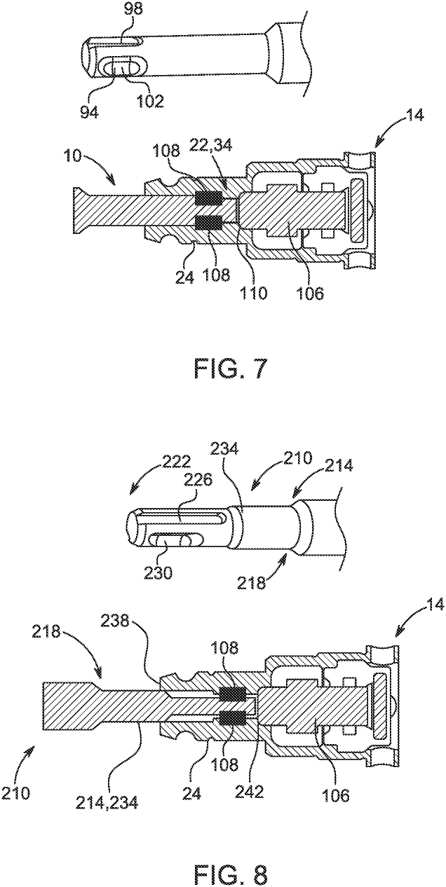

FIGS. 1-3 illustrate a tool bit 10. In the illustrated embodiment, the tool bit is a cutting tool for use with a power tool 14 (FIG. 7), such as, for example, a drill, a driver drill, a screwdriver, a hammer drill, a rotary hammer and the like. The tool bit 10 may be used to cut holes or drill into a workpiece made out of brick, block, tile, metal, marble, concrete, plaster, wood, plastic, dry-wall, rebar and the like. In some scenarios, the tool bit 10 may be used to cut into a workpiece that is reinforced with rebar. As such, the tool bit 10 may also be referred to as a rebar cutter bit. The illustrated tool bit 10 comes in a variety of sizes that correspond to the diameter of a hole to be created in a workpiece. For example, possible sizes of the tool bit 10 may be ⅛″, ¼″, ⅜″, and ½″. In some embodiments, the size of the tool bit 10 may be between ⅜″and 1-½″. In other embodiments, the tool bit 10 may be other sizes.

With reference to FIG. 1, the tool bit 10 includes a first or workpiece-engaging end 18, a second or rearward end 22 configured to be received in a tool holder or chuck 24 of a power tool 14, and an axis of rotation 26 centrally located on the tool bit 10 and extending from the first end 18 to the second end 22. The tool bit 10 also includes a body 30 and a shank 34. The body 30 defines the first end 18 and cuts into the workpiece. The shank 34 defines the second end 22 and is configured to be coupled to the power tool 14.

The illustrated body 30 includes a helical rib 38 that defines a flute 42. In the illustrated embodiment, the tool bit 10 includes a single rib 38 that defines a single flute 42. In other embodiments, the tool bit 10 may include more than one rib 38 that defines multiple flutes 42. In other embodiments, the body 30 may not include a rib 38. The ribs 38 and flutes 42 may be helically wrapped around the body 30 at a variable helix angle. In other words, the angle at which the flutes 42 wrap about the body 30 changes as the flutes 42 extend from the first end 18 towards the second end 22. The ribs 38 and flutes 42 facilitate chip removal from a workpiece during a cutting operation.

The illustrated body 30 also includes one or more apertures 46 that extend into a bore 50 of the tool bit 10. The apertures 46 facilitate removal of material (e.g., cutting chips, slugs, etc.) from the body 30 and may also be referred to as slug removal holes. For example, a user may remove the debris or slugs from the bore 50 by extending a pick or screwdriver into one of the apertures 46. In the illustrated embodiment, the body 30 includes two apertures 46. In other embodiments, the body 30 may only include a single aperture 46 or may include more than two apertures 46. In some embodiments (particularly for smaller diameter tool bits), the apertures 46 and the bore 50 may be omitted.

With reference to FIG. 2, the body 30 includes a cutting head 54 adjacent the first end 18 of the tool bit 10. The cutting head 54 includes an annular rim 58 that defines an opening 62 that extends into the bore 50 of the tool bit 10. The opening 62 is configured to receive debris (e.g., slugs) during a cutting operation. For example, the opening 62 may receive cutting chips and other material that form into slugs in the bore 50 while cutting into a workpiece. As mentioned above, in some embodiments, the bore 50 may be omitted from the tool bit 10.

With continued reference to FIG. 2, the illustrated cutting head 54 includes a plurality of slots 66 that each receive a cutting tooth 70. In the illustrated embodiment, the cutting head 54 includes six slots 66 to receive six cutting teeth 70. In other embodiments, the cutting head 54 may include more than or less than six slots 66 to receive a corresponding number of cutting teeth 70. As shown, in FIG. 3, each cutting tooth 70 defines a cutting edge 74 that extends further from the first end 18 of the body 30 than the annular rim 58 to contact a workpiece. The cutting edge 74 defines a plurality of relief surfaces 78. In some embodiments, the relief surfaces 78 may vary per cutting tooth 70 to provide a different cutting pattern. For example, every other cutting tooth 70 may include four relief surfaces 78 while every adjacent cutting tooth 70 includes three relief surfaces 78. In the illustrated embodiment, the cutting edge 74 of each tooth is aligned on a leading edge each of the slots 66. In some embodiments, the cutting teeth 70 are made of carbide. In further embodiments, the cutting teeth 70 may be coupled to the body 30 by brazing or welding. In further embodiments, a single carbide cutting portion may be coupled to the cutting head. The carbide cutting portion would include a plurality of cutting teeth. The cutting teeth may be integral with the carbide cutting portion. For example, the cutting teeth may be carved, grounded, or cut into the carbide cutting head. Further, the carbide cutting portion may be coupled to the cutting head by welding, brazing or other methods.

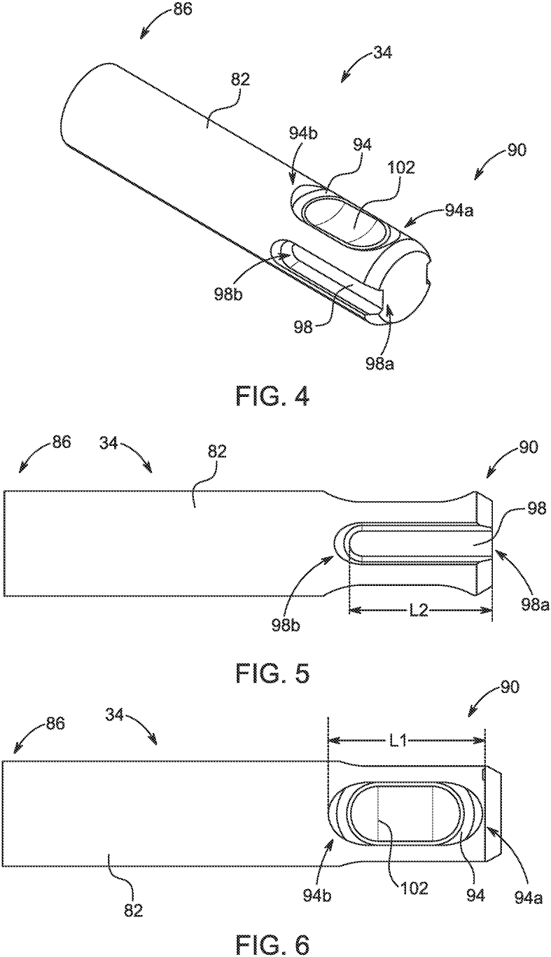

FIGS. 4-6 illustrate the shank 34 of the tool bit 10. In some embodiments, the shank 34 may be formed integral with the body 30. In other embodiments, the shank 34 may be secured to the body 30 by brazing, welding, or other methods. In the illustrated embodiment, the shank 34 is a modified SDS shank. The shank 34 includes a main portion 82 having a first end 86 adjacent the body 30 and a second end 90 opposite the first end 86. The first end 86 of the main portion 82 provides a blank surface that may include laser etching indicating to the user the size of the tool bit 10 or other information. The second end 90 of the shank 34 includes a pair of ball detents 94 and a pair of slots 98 (although only one ball detent 94 and one slot 98 is shown in FIGS. 4-6). The ball detents 94 are on diametrically opposite sides of the axis of rotation 26 from one another. Similarly, the slots 98 are on diametrically opposite sides of the axis of rotation 26 from one another other. In some embodiments, the tool bit 10 may only include a single ball detent 94 and/or a single slot 98, or the tool bit 10 may include more than two ball detents 94 and/or slots 98. Each illustrated ball detent 94 is positioned 90 degrees circumferentially from an adjacent slot 98 and vice versa. The ball detents 94 further include an indent 102 that is further recessed into the shank 34 in a direction radially toward the axis of rotation 26 than the ball detent 94.

In the illustrated embodiment, a length L1 of each ball detent 94 is similar to a length L2 of each slot 98. In other words, a ratio of the length L1 of the ball detents 94 to the length L2 of the slots 98 is a range between 0.85 and 1.15. Further, the ball detents 94 and the slots 98 only extend along a portion of the shank 34. Specifically, in the illustrated embodiment, the length L1 of the ball detents 94 and the length L2 of the slots 98 extend between one-fifth and one-third a total length of the shank 34. As such, the slots 98 and detents 94 are shortened compared to other or standard SDS shanks. In further embodiments, if the length of the shank 34 were increased, the length L1 of the ball detents 94 and the length L2 of the slots 94 would remain constant. In such an embodiment, the length L1 of the ball detents 94 and the length L2 of the slots 94 may be between 0.2 inches and 1 inch.

The illustrated slots 98 do not extend past the ball detents 94 in a direction parallel to the axis of rotation 26 (FIG. 1). Each slot 98 is formed through the second end 90 of the shank 34 and extends toward the first end 86. Each slot 98 has a proximal end 98a at the second end 90 and a distal end 98b opposite the proximal end 98a. Each ball detent 94, in contrast, does not extend through the second end 90 such that the ball detents 94 are bounded on all sides. Each ball detent 94 has a proximal end 94a adjacent the second end 90 and a distal end 94b opposite the proximal end 94a. In conventional SDS shanks, the slots 98 typically extend a further distance along the shank 34 and past the ball detents 94. That is, the distal ends 98b of the slots 98 are typically closer than the distal ends 94b of the ball detents 94 to the first end 86 of the shank 34. Stated another way, in conventional SDS shanks, the distal ends 98b of the slots 98 are spaced further than the distal ends 94b of the ball detents 94 from the second end 90 of the shank 34. In the illustrated embodiment, the distal ends 98b of the slots 98 are spaced generally the same distance from the first and second ends 86, 90 of the shank 34 as the distal ends 94b of the ball detents 94. In some embodiments, the distal ends 98b of the slots 98 may be spaced further than the distal ends 94b of the ball detents 94 from the first end 86 of the shank 34. In such embodiments, the distal ends 98b of the slots 98 may be closer than the distal ends 94b of the ball detents 94 to the second end 90 of the shank 34.

FIG. 7 illustrates the tool bit 10 coupled to the power tool 14. The power tool 14 includes the chuck 24 to receive the tool bit 10 and an anvil 106. The anvil 106 is configured to impart an impact force on a tool bit received within the chuck 24. To operate the tool bit 10, the second end 22 of the tool bit 10 (e.g., the shank 34) is inserted into the chuck 24 of the power tool 14. Pins or keys of the power tool 14 are received in the slots 98 to transfer rotational movement to the tool bit 10 and locking spheres 108 (schematically illustrated) are received in the indents 102 of the ball detents 94 to lock the tool bit 10 within the chuck 24. The pins or keys and the locking spheres 108 are movable axially within the ball detents 94 and the slots 98, respectively, to reduce the fatigue on the shank 34. Additionally, as mentioned above, the shortened lengths of the ball detents 94 and the slots 98 prevent the shank 34 from fully inserting into the chuck 24, providing a space 110 between the tool bit 10 and the anvil 106. As such, during a cutting operation, the anvil 106 does not contact the second end 90 of the shank 34 to impart an impact force on the tool bit 10. In other words, the space 110 inhibits the second end 22 of the tool bit 10 from contacting the anvil 106 during operation of the power tool 14.

In other embodiments, the shank 34 may be made from a different material than the body 30. For example, the end of the shank 34 may be made of a softer material than the material used for the body 30. In such an embodiment, the end of the shank 34 would be operable to absorb an impact from the anvil 106 without harming the integrity of the tool bit 10. In further embodiments, the shank 34 may be spring loaded to absorb the impact energy from the anvil 106. In such an embodiment, the shank 34 may include a resilient member that biases the shank 34 away from the body. Then, if the shank 34 were to receive an impact force from the anvil 106, the shank 34 would move against the bias of the resilient member to absorb the impact energy from the anvil 106 preventing harm to the tool bit 10.

Providing a tool bit 10 with a modified SDS shank 34 that includes slots 98 inhibits the tool bit 10 from being impacted by an anvil 106 of a power tool 14 when received in the chuck 24 of the power tool 14, which may extend the life of the tool bit 10.

FIG. 8 illustrates a tool bit 210 according to another embodiment of the invention. The tool bit 210 is similar to the tool bit 10, but includes a different shank 214. The illustrated shank 214 includes a first end 218 and a second end 222 opposite the first end 218. The first end 218 includes a pair of elongated slots 226 and a pair of ball detents 230. In the illustrated embodiments, the slots 226 and the ball detents 230 are typical of a conventional SDS design. Locking spheres 108 are received in the ball detents 230 to lock the tool bit 10 within the chuck 24. The shank 214 also includes a projection. The projection is positioned adjacent distal ends of the sots 226. In the illustrated embodiment, the projection is a shoulder 234 formed at an increased diameter portion of the shank 214. The shoulder 234 extends continuously around a circumference of the shank 214. As such, the shoulder 234 is integrally formed with the shank 214. When inserted into the chuck 24 of the power tool 14, the shoulder 234 abuts a forward surface 238 of the chuck 24, preventing the shank 214 from fully inserting into the chuck 24. A space 242 is left between the shank 214 and the anvil 106 so that the anvil 106 cannot contact the second end of the shank 214 to impart an impact force on the tool bit 210 during a cutting operation. In other embodiments, the projection may have other configurations. For example, the projection may be a separate piece that is secured (e.g., brazed or welded) to the shank 214. Alternatively, the projection may be a single, discrete projection on the shank 214 or may be a series of discrete projections.

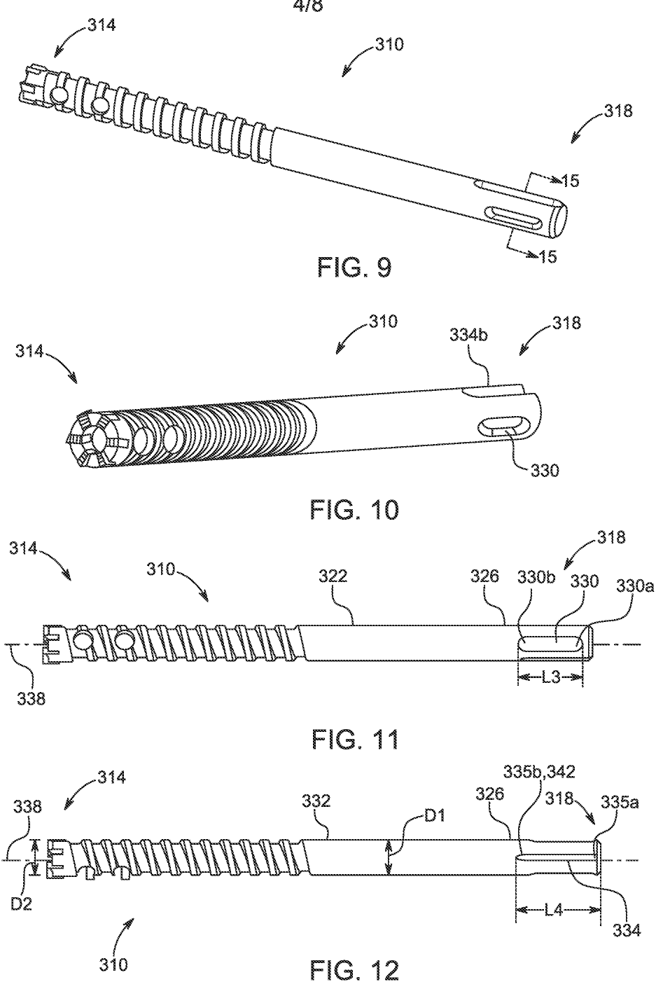

In some embodiments, shank 34 of the tool bit 10 or the shank 214 of the tool bit 210 may be SDS max designs. Providing a tool bit 10, 210 with a modified shank that inhibit impact from an anvil 106 allows for heavier rebar cutters that include an SDS max design. For example, FIGS. 9-12 illustrate a tool bit 310 according to another embodiment of the invention. The tool bit 310 is similar to the tool bits 10, 210 but includes a modified SDS max shank according to another embodiment.

In the illustrated embodiment, the tool bit 310 includes a first or workpiece engaging end 314 and a second or rearward end 318 configured to be received in a tool holder or a chuck of a power tool. The tool bit 310 also includes a body 322 extending between the first and second ends 314, 318 and a shank 326 that defines the second end 318. In the illustrated embodiment, the shank 326 is a modified SDS max shank. In comparison, the shank 34 of the tool bit 10 shown in FIG. 1 may be referred to as a modified SDS plus shank. Generally, SDS max shanks include a greater diameter than SDS plus shanks. For example, the shank 326 may include a max diameter D1 between ½″ and 1¾″, whereas SDS plus shanks may include a diameter between 5/32″ and 1¼″. Specifically, the shank 326 may have a max diameter that is 18 millimeters or 0.71 inches. Additionally, as will be described in more detail below, SDS max shanks include at least one wider slot with a projection that separates the slot into two distinct smaller slots (FIG. 15). As shown in FIGS. 11 and 12, a max diameter D1 of the shank is generally equal to a max diameter D2 of the body 322 or the tool bit 310. Including a similar diameter between the body 322 and the shank 326 allows the tool bit 310 to withstand higher torques when engaging a workpiece.

FIGS. 11 and 12 illustrate the shank 326 of the tool bit 310. The shank 326 may be described as a non-working end of the accessory that is inserted into the chuck 24 of the power tool 14 to transmit motion to the workpiece engaging end 314. The length of the shank 326 serves as a portion of the tool bit 310 to distance the body 322 and the workpiece engaging end 314 from the chuck 24. In some embodiments, the shank 326 may be formed integral with the body 322. In other embodiments, the shank 326 may be secured to the body 322 by brazing, welding, or other methods. The shank 326 includes a pair of ball detents 330, a first slot 334a, and a second slots 334b (FIG. 10). The ball detents 330 are on diametrically opposite sides of an axis of rotation 338 from one another. Similarly, the slots 334a, 334b are on diametrically opposite sides of the axis of rotation 338 from one another other. Each illustrated ball detent 330 is positioned 90 degrees circumferentially from an adjacent slot 334a, 334b and vice versa. As shown in FIG. 15, the first slot 334a includes a similar cross-sectional profile as the slots 98 described above. The second slot 334b includes a projection 336 that defines two smaller slots 337a, 337b. The two smaller slots 337a, 337b provide more surface area for the chuck of a rotary power tool to engage the tool bit 310 allowing better transfer of torque from the power tool to the tool bit that may be needed for the wider dimensions of an SDS max shank.

In the illustrated embodiment, a length L3 of each ball detent 330 is similar to a length L4 of each slot 334a, 334b. In other words, a ratio of the length L3 of the ball detents 330 to the length L4 of the slots 334a, 334b is in a range between 0.85 and 1.15. Further, the ball detents 330 and the slots 334a, 334b only extend along a portion of the shank 326. Specifically, in the illustrated embodiment, the length L3 of the ball detents 330 and the length L4 of the slots 334a, 334b extend between one-tenth and seven-tenths a total length of the shank 34. In addition, the length L3 of the ball detents 330 and the length L4 of the slots 334a, 334b extend long enough to engage the chuck 24 of the power tool 14 to transfer rotation, but short enough to not receive impact from the anvil 106. As such, the slots 334a, 334b and detents 330 are shortened compared to other or standard SDS max shanks. In further embodiments, if the length of the shank 326 were increased, the length L3 of the ball detents 330 and the length L4 of the slots 334a, 334b would remain constant. In such an embodiment, the length L3 of the ball detents 330 and the length L4 of the slots 334a, 334b may be between 0.2 inches and 2 inches.

The illustrated slots 334a, 334b extend slightly past the ball detents 330 in a direction parallel to the longitudinal axis 338. Each slot 334a, 334b is formed through the second end 318 of the tool bit 310 and extends toward the first end 314. Each slot 334a, 334b has a proximal end 335a at the second end 318 and a distal end 335b opposite the proximal end 335a. The distal end 335b defines an inclined surface 342 that extends to the outer periphery of the shank 326. Each ball detent 330, in contrast, does not extend through the second end 318 such that the ball detents 330 are bounded on all sides. Each ball detent 330 has a proximal end 330a adjacent the second end 318 and a distal end 330b opposite the proximal end 330a. In conventional SDS shanks, the slots 334a, 334b typically extend a further distance along the shank 326 and past the ball detents 330. That is, the distal ends 335b of the slots 334a, 334b are typically closer than the distal ends 330b of the ball detents 330 to the first end 314 of the tool bit 310. Stated another way, in conventional SDS shanks, the distal ends 335b of the slots 334a, 334b are spaced further than the distal ends 330b of the ball detents 94 from the second end 318. In the illustrated embodiment, the distal ends 335b of the slots 334a, 334b are spaced generally the same distance from the first and second ends 314, 318 as the distal ends 330b of the ball detents 330. In some embodiments, the distal ends 335b of the slots 334a, 334b may be spaced further than the distal ends 330b of the ball detents 330 from the first end 314. In such embodiments, the distal ends 335b of the slots 334a, 334b may be closer than the distal ends 330b of the ball detents 330 to the second end 318.

The tool bit 310 is configured to be inserted into a chuck of a power tool that receives SDS max shanks. Generally, rotary power tools configured to receive SDS max tool bits are operable in two modes: a hammer only mode, in which an anvil provides only a percussive force to the end of a tool bit, and a rotary hammer mode, in which the anvil provides a percussive force to a tool bit while the tool bit is rotated. Similar to the tool bit 10, the shortened lengths of the ball detents 330 and the slots 334a, 334b prevent the shank 326 from fully inserting into the chuck of a SDS max rotary power tool. As such, during a cutting operation, an anvil 106 does not contact the shank 326 to impart an impact force on the tool bit 10.

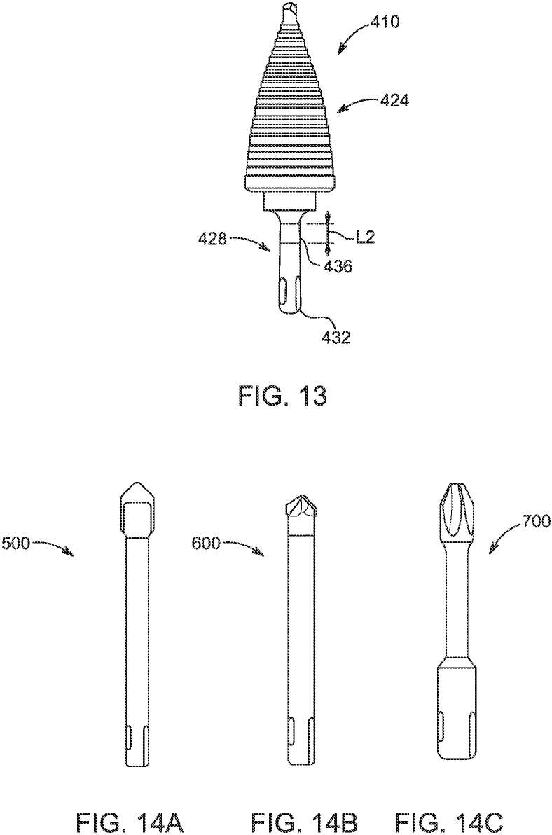

FIG. 13 illustrates a tool bit 410 including a shank 428 having a tool engagement portion 432 and a reduced diameter portion 436. The reduced diameter portion 436 may be included on the shanks 34, 214, 326 of the tool bits 10, 210, 310 discussed above. The reduced diameter portion 436 removes localized regions of high stress and discontinuities, thereby increasing the durability of the shank 428 to extend the operational lifetime of the tool bit 410. In some embodiments, the reduced diameter portion 436 may be disposed between the shank 428 and a body 424 of the tool bit 410. The reduced diameter portion 436 may provide a transition from the shank 428 to the rest of the body 424. In further embodiments, the reduced diameter portion 436 may be between 70%-99% of the diameter of the shank 428. For example, when the reduced diameter portion 436 is included on the shank 326 of the tool bit 310, the reduced diameter portion 436 may be between 70%-99% of the diameter D1 of the shank 326. The reduced diameter portion 436 may be similar to the reduced diameter section discussed in U.S. Pat. No. 10,421,130, the entire contents of which are hereby incorporated by reference.

In some embodiments, the tool bits 10, 210, 310, 410 may be coated with a rust preventive coating that is applied to the entire tool bit 10, 210, 310, 410. In further embodiments, the tool bits 10, 210, 310, 410 may be coated with a PVD (physical vapor deposition) coating, such as titanium-nitride coating or with black oxide.

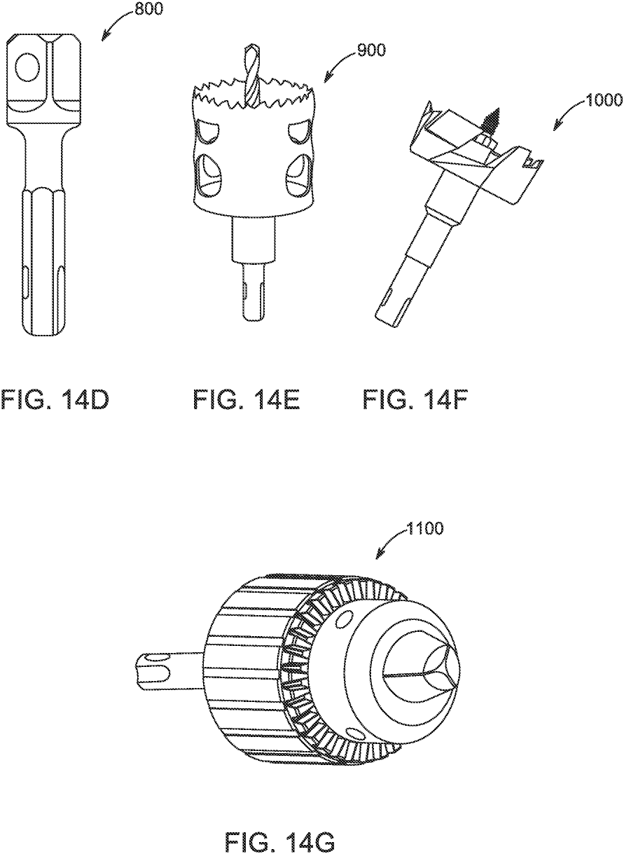

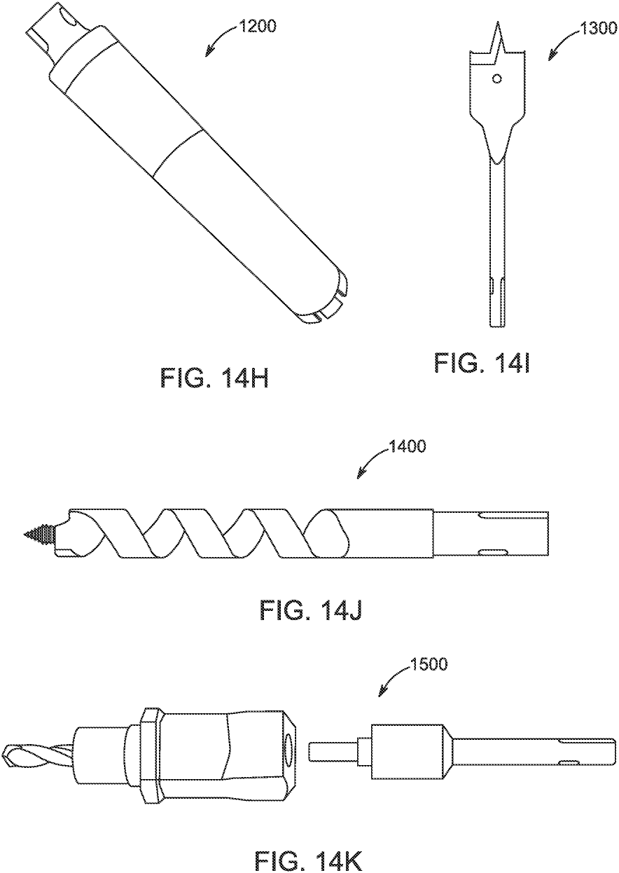

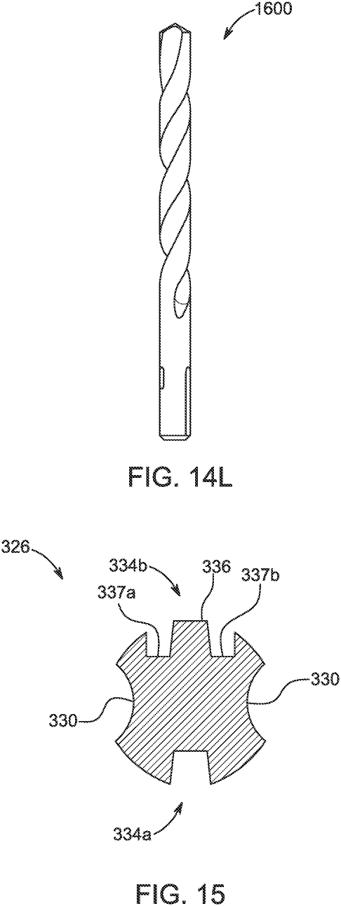

In further embodiments, the shank 34 of the drill bit 10, the shank 214 of the drill bit 210, or the shank 326 of the drill bit 310 may be used with a number of different tool bits. FIGS. 14A-14L disclose tool bits that may include one of the shanks 34, 214, 326 discussed above. For example, the shanks 34, 214, 326 may be used with a glass and tile bit 500 (FIG. 14A), a natural stone bit 600 (FIG. 14B), a driver bit 700 (FIG. 14C), a socket adapter 800 (FIG. 14D), a hole saw assembly including a shank 900 (FIG. 14E), a self-feed bit 1000 (FIG. 14F), a chuck adapter 1100 (FIG. 14G), a core drilling bit 1200 (FIG. 14H), a spade drill bit 1300 (FIG. 14I), a wood auger 1400 (FIG. 14J), an anchor setting kit assembly 1500 (FIG. 14K), or a metal/concrete bit 1600 (FIG. 14L).

Although the invention has been described in detail with reference to certain embodiments above, variations and modifications exist within the scope and spirit of the invention. Various features and advantages of the invention are set forth in the following claims.

What is claimed is:

1. A tool bit for use with a power tool having a chuck and an anvil, the tool bit comprising:
a first end;
a second end opposite the first end;
a body defining the first end of the tool bit; and
a shank coupled to the body and defining the second end of the tool bit, the shank configured to be inserted into the chuck of the power tool, the shank including
a slot formed through the second end, the slot configured to receive a portion of the chuck to transfer rotational movement from the power tool to the tool bit,
a ball detent spaced circumferentially from the slot, the ball detent configured to receive a locking sphere of the chuck to lock the tool bit within the chuck, and
a projection, the projection configured to contact a surface of the chuck and limit insertion of the shank into the chuck, thereby providing a space between the second end of the tool bit and the anvil.

2. The tool bit of claim 1, wherein the space inhibits the second end of the tool bit from contacting the anvil during operation of the power tool.

3. The tool bit of claim 1, wherein the projection is a shoulder formed at an increased diameter portion of the shank.

4. The tool bit of claim 3, wherein the shoulder extends continuously around a circumference of the shank.

5. The tool bit of claim 3, wherein the increased diameter portion is disposed between the slot and the body, and wherein the projection is a first projection, the tool bit further including a second projection positioned between the increased diameter portion and the body.

6. The tool bit of claim 1, wherein the slot has a proximal end adjacent the second end of the tool bit and a distal end opposite the proximal end, and wherein the projection is adjacent the distal end of the slot.

7. The tool bit of claim 1, wherein the slot is a first slot, wherein the ball detent is a first ball detent, and wherein the shank further includes
a second slot positioned diametrically opposite from the first slot and formed through the second end, the second slot configured to receive another portion of the chuck to transfer rotational movement from the power tool to the tool bit, and
a second ball detent positioned diametrically opposite from the first ball detent, the second ball detent configured to receive another locking sphere of the chuck to lock the tool bit within the chuck.

8. The tool bit of claim 1, wherein the ball detent is bounded on all sides.

9. A tool bit for use with a power tool having a chuck and an anvil, the tool bit comprising:
a first end;
a second end opposite the first end;
a body defining the first end of the tool bit; and
a shank coupled to the body and defining the second end of the tool bit, the shank configured to be inserted into the chuck of the power tool, the shank including
a slot formed through the second end, the slot configured to receive a portion of the chuck to transfer rotational movement from the power tool to the tool bit,
a ball detent spaced circumferentially from the slot, the ball detent configured to receive a locking sphere of the chuck to lock the tool bit within the chuck,
an increased diameter portion positioned between the slot and the body, and
a projection disposed between the slot and the increased diameter portion, the projection sloping toward the increased diameter portion and configured to limit insertion of the shank into the chuck.

10. The tool bit of claim 9, wherein the projection is configured to contact a surface of the chuck, thereby providing a space between the second end of the tool bit and the anvil.

11. The tool bit of claim 9, wherein the body has a greater diameter than the increased diameter portion of the shank.

12. The tool bit of claim 11, wherein the projection is a first projection, the tool bit further including a second projection that slopes from the increased diameter portion toward the body.

13. The tool bit of claim 9, wherein the slot is longer than the ball detent such that an end of the slot that is distal to the second end of the tool bit is positioned between the projection and an end of the ball detent that is distal to the second end of the tool bit.

14. The tool bit of claim 9, wherein the projection is a shoulder that extends continuously around a circumference of the shank.

15. A tool bit for use with a power tool having a chuck and an anvil, the tool bit comprising:
a first end;
a second end opposite the first end such that an axis of rotation is defined between the first end and the second end;
a body defining the first end of the tool bit; and
a shank coupled to the body and defining the second end of the tool bit, the shank configured to be inserted into the chuck of the power tool, the shank including
a slot formed through the second end, the slot configured to receive a portion of the chuck to transfer rotational movement from the power tool to the tool bit, the slot having a proximal slot end adjacent the second end of the tool bit and a distal slot end opposite the proximal slot end,
a ball detent spaced circumferentially from the slot, the ball detent configured to receive a locking sphere of the chuck to lock the tool bit within the chuck, the ball detent having a proximal ball detent end adjacent the second end of the tool bit and a distal ball detent end opposite the proximal ball detent end, and
a projection extending away from and circumferentially around a circumference of the shank,
wherein the distal slot end is positioned between the distal ball detent end and the projection.

16. The tool bit of claim 15, wherein the projection is configured to contact a surface of the chuck and limit insertion of the shank into the chuck, thereby providing a space between the second end of the tool bit and the anvil.

17. The tool bit of claim 16, wherein the space inhibits the second end of the tool bit from contacting the anvil during operation of the power tool.

18. The tool bit of claim 15, wherein the slot extends through the second end of the tool bit such that the proximal slot end is located at the second end of the tool bit, and wherein the proximal ball detent end is spaced from the second end of the tool bit.

19. The tool bit of claim 15, wherein the shank further includes an increased diameter portion, wherein the projection is formed at a transition to the increased diameter portion, and wherein the body has a greater diameter than the increased diameter portion of the shank.

20. The tool bit of claim 19, wherein the projection is a first projection, the tool bit further including a second projection between the increased diameter portion and the body.
